(19) United States
(12) Patent Application Publication
(10) Pub. No.: US 2004/0108820 A1
(43) Pub. Date: Jun. 10, 2004

(54) Arrangement for lighting fixture

(75) Inventor: Yrjo Hartikka, Pennala (FI)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Teknoware Oy, Lahti (FI)

(21) Appl. No.: 10/680,667

(22) Filed: Oct. 7, 2003

(30) Foreign Application Priority Data
Oct. 7, 2002 (FI) 20021781

(51) Int. Cl. H05B 37/00

(52) U.S. Cl. 315/193

(57) ABSTRACT

A lighting arrangement comprising a power source, two or more lighting fixtures and switches for switching on power in the lighting fixtures. With the arrangement of the invention, two or more lighting fixtures can be coupled to the same power source. In the invention, the power source is started when one or more voltage supplies are energized. The switches are controlled by means of control wires so that each switch is responsive to energizing the corresponding voltage supply.

### BACKGROUND OF THE INVENTION

The invention relates to an arrangement used in connection with lighting fixtures, wherein an electric circuit supplying the lighting fixtures comprises a power source and switches for switching on electric current in a lighting fixture by means of the power source. A typical application of the arrangement according to the invention is the interior lighting of public transport vehicles, but it can also be used in any other object requiring similar lighting.

For instance, in public transport vehicles, such as buses, trains and trams, or inside buildings, such as in corridors of hotels and blocks of serviced flats, it is well-grounded that the lighting of a space can be adapted according to changing circumstances. Therefore, the lighting is usually planned so that it is possible to have less or more light by using only some of the lighting fixtures. For reasons of comfort or safety, passenger cabins of buses, for example, need to be provided with a different lighting in the night-time than in the daytime or while the passenger cabin is empty. An example of improving comfort in buses by means of internal lighting is the use of passenger-specific reading lights. This means that passengers themselves can adjust the lighting of their own seat, depending on whether they want to read or rest, for example.

The lighting as described above is often implemented by supplying power to a lighting fixture from a power source, which generates a required voltage, e.g. direct-current voltage. The lighting fixture is switched on by a separate switch, which starts the supply of power from the power source to the lighting fixture. The power source compensates the voltage and keeps it at a certain level, and thus the lighting fixture may operate reliably without disturbances caused by variations in the voltage supply.

A problem with the above arrangement is that each lighting fixture requires a separate power source. Power sources are expensive, and thus the costs caused by implementing the lighting, particularly in a system comprising several lighting fixtures, are relatively high.

### BRIEF DESCRIPTION OF THE INVENTION

It is thus an object of the invention to provide an arrangement used in connection with a lighting fixture to solve the above problems. The object of the invention is achieved by the arrangement, which is characterized by what is disclosed in the independent claim. The preferred embodiments of the invention are disclosed in the dependent claims.

The invention is based on the idea that two or more lighting fixtures may be simultaneously coupled to the same power source. The power source, which may be a rectifier, a regulated current source or the like, accommodates the external voltage supply suitable for the operating device, such as a lighting fixture. The power source is started when one or more voltage supplies are energized. Each lighting fixture has its own control wire and a switch for coupling the lighting fixture to the power source. Information on the selection of the lighting fixture is transmitted via the control wire to the switch. In the arrangement of the invention, the switches operate in response to energizing the corresponding voltage supply.

The arrangement of the invention provides the advantage that as each lighting fixture uses a common power source, instead of a separate power source, lighting implementation costs are saved. The solution having one power source also requires less wiring than current solutions. The arrangement of the invention reduces energy consumption, because the power source applies no current when no lighting fixture is switched on, and thus no-load losses can be avoided.

### BRIEF DESCRIPTION OF THE FIGURES

The invention will now be described in greater detail in association with preferred embodiments, with reference to the attached drawing, in which:

FIG. 1 shows a simplified diagram of an arrangement according to the invention.

### DETAILED DESCRIPTION OF THE INVENTION

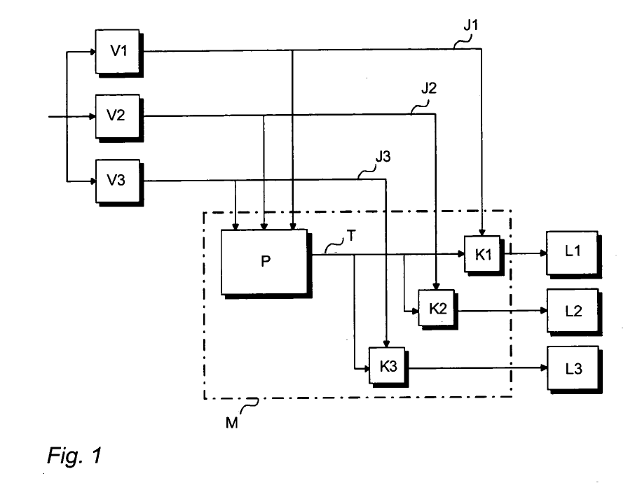

FIG. 1 shows an arrangement of the invention implemented by way of example with three lighting fixtures L1, L2, L3. Each lighting fixture L1, L2, L3 is switched on when a switch K1, K2, K3 corresponding to the lighting fixture is switched on so that the lighting fixture L1 is switched on by the switch K1, the lighting fixture L2 by the switch K2 and the lighting fixture L3 by the switch K3. The switches K1, K2, K3 are controlled by means of corresponding control wires J1, J2, J3. Via the control wire J1, J2, J3, a signal switching on the switch K1, K2, K3 is transmitted from a voltage supply V1, V2, V3 to the switch K1, K2, K3. Voltage is supplied from the voltage supply to a power source P via wires connecting the voltage supplies V1, V2, V3 to the power source. As a result of energizing even one voltage supply V1, V2, V3, the power source P is started. The power source P provides those lighting fixtures L1, L2, L3 whose corresponding switches K1, K2, K3 are switched on with power supply T. The voltage supply V1, V2, V3 may be energized, for instance, by means of a breaker (not shown in FIG. 1) of a corresponding lighting fixture L1, L2, L3.

According to a preferred embodiment of the invention, the power source P applies no current, if none of the lighting fixtures L1, L2, L3 is switched on, i.e. if none of the voltage supplies V1, V2, V3 is energized.

According to a further preferred embodiment of the invention, the power supply P and the switches K1, K2, K3 are integrated into the same module M. Thus they can be physically located in the same apparatus.

Naturally, the purpose is not to restrict the number of lighting fixtures to two or three in the arrangement of the invention, but there can also be any number of lighting fixtures, in which case there should also be a corresponding number of necessary switches and control wires. The term ‘lighting fixture’ should be understood as broadly as possible. It can refer to an incandescent lamp, fluorescent lamp or LED, for instance. The lighting fixture can be considered to refer to a group of lighting fixtures where two or more lighting fixtures are coupled to the same supply supplied by the power source. In this context, a switch refers to a relay or a suitable semiconductor component, for instance.

It is obvious to a person skilled in the art that as technology advances, the basic idea of the invention can be implemented in various ways. The invention and its embodiments are thus not restricted to the above examples but may be varied within the scope of the claims.

1. A lighting arrangement comprising a power source, at least two lighting elements, at least two corresponding switching elements and at least two corresponding voltage supplies, each switching element being arranged to control the corresponding lighting element, the power source being arranged to be responsive to energizing said at least one of voltage supplies; and each switching element being arranged to be responsive to energizing the corresponding voltage supply to supply power produced by the power source to the corresponding lighting element.

2. The lighting arrangement as claimed in claim 1, wherein at least one said lighting element comprises one or more light sources.

3. The lighting arrangement as claimed in claim 1, wherein said switching elements are integrated into the power source.

4. The lighting arrangement as claimed in claim 1, wherein the power source is de-energized if no lighting element is coupled thereto.

5. The lighting arrangement as claimed in claim 1, wherein said lighting elements are incandescent lamps.

6. The lighting arrangement as claimed in claim 1, wherein said lighting elements are LEDs.

7. The lighting arrangement as claimed in claim 1, wherein said lighting elements are fluorescent lamps.

8. The lighting arrangement as claimed in claim 1, wherein said switching elements are relays.

9. The lighting arrangement as claimed in claim 1, wherein said switching elements are semiconductor components.
